(19) United States
(12) Patent Application Publication
(10) Pub. No.: US 2023/0250895 A1
(43) Pub. Date: Aug. 10, 2023

(54) DEVICES AND METHODS TO FACILITATE THE HANDLING OF PIPE SECTIONS

(71) Applicant: Earl McDonald, Georgetown, KY (US)

(72) Inventor: Earl McDonald, Georgetown, KY (US)

(21) Appl. No.: 18/092,071

(22) Filed: Dec. 30, 2022

Related U.S. Application Data
(60) Provisional application No. 63/295,786, filed on Dec. 31, 2021.

(51) Int. Cl. F16L 1/06

(52) U.S. Cl. CPC F16L 1/06

(57) ABSTRACT

According to some embodiments, a device for assisting manipulation of an elongated member comprises a head member, at least one strap to secure to first and second ends of the head member, the at least one strap being sized and configured to extend around the elongated member, wherein the at least one strap is configured to tighten around the elongated member, wherein tightening of the at least one strap around the elongated member brings the head member toward an exterior surface of the elongated member, and a connector coupled to the head member, wherein the connector is configured to secure to an actuator or movable device in order to exert desired forces or moments to the device and the elongated member to which the device is secured, wherein use of the device eliminates the need for contact between a user and the elongated member.

### CROSS-REFERENCE TO RELATED APPLICATIONS

This application claims the priority benefit of U.S. Provisional Patent Application No. 63/295,786, filed Dec. 31, 2021, the contents of which are incorporated by reference herein in their entirety.

### BACKGROUND

### Field

This application relates generally to piping technologies, and more specifically, to the handling and manipulation of piping sections and other elongated members.

### Description of the Related Art

The handling of piping sections, especially larger diameter and/or longer pipes, can be difficult and dangerous and can create additional challenges. Further, coatings and other exterior layers or features on piping sections sometimes need to be protected, including during the transport, installation and other activities related to the handling of piping sections. Accordingly, pipe handling devices can be used to provide for enhanced pipe handling procedures.

### SUMMARY

According to some embodiments, a device for assisting manipulation of an elongated member comprises a head member having a curved shape, at least one strap configured to secure to a first end and a second end of the head member, the at least one strap being sized and configured to extend around the elongated member, wherein the at least one strap is configured to tighten around the elongated member, wherein tightening of the at least one strap around the elongated member brings the head member toward an exterior surface of the elongated member, and a connector coupled to the head member, wherein the connector is configured to secure to an actuator or movable device in order to exert desired forces or moments to the device and the elongated member to which the device is secured, wherein use of the device eliminates the need for contact between a user and the elongated member.

According to some embodiments, the device further comprises at least one protective member positioned at least partially between the head member and the elongated member, the at least one strap comprises a ratchet strap.

According to some embodiments, the elongated member comprises a pipe section.

According to some embodiments, the connector is configured to secure to a rod, wherein the rod can be selectively manipulated by a user. In some embodiments, the connector is configured to secure to a separate piece of equipment, wherein the separate piece of equipment is configured to exert a desired combination of forces and moments on the device and the elongated member.

According to some embodiments, a device for assisting manipulation of a targeted piping section comprises a head member having a curved shape, the head member comprising a first end and a second end, a first coupling positioned at or near the first end of the head member, a second coupling positioned at or near the second end of the head member, at least one strap configured to secure to the first end and the second end of the head member, the at least one strap being sized and configured to extend around the targeted piping section, wherein the at least one strap is configured to tighten around the targeted piping section, wherein tightening of the at least one strap around the targeted piping brings the head member toward an exterior surface of the targeted piping member, and a connector coupled to the head member, wherein the connector is configured to secure to an actuator or movable device in order to exert desired forces or moments to the device and the targeted piping section to which the device is secured, wherein use of the device eliminates the need for direct contact between a user and the targeted piping section.

According to some embodiments, the device further includes at least one protective member positioned at least partially between the head member and the targeted piping section, wherein at least one of the first and second couplings is configured to be moved between open and closed positions to selective release and receive the at least one strap, and wherein the at least one strap comprises a ratchet strap.

According to some embodiments, at least one of the first and second couplings is configured to be moved between open and closed positions to selective release and receive the at least one strap. In some embodiments, the at least one of the first and second couplings comprises a quick connect coupling. In some embodiments, the at least one strap comprises a ratchet strap.

According to some embodiments, the device further comprises at least one protective member positioned at least partially between the head member and the targeted piping section. In some embodiments, the protective member comprises a rubber or other elastomeric material. In one arrangement, the at least one protective member is secured to the head member. In other embodiments, the at least one protective member is not secured to the head member.

According to some embodiments, the connector is fixedly secured to the head member. In some arrangements, the connector is removably secured to the head member.

According to some embodiments, the head member comprises a metal (e.g., steel). In other embodiments, the head member does not comprise a metal.

According to some embodiments, the connector is configured to secure to a rod, wherein the rod can be selectively manipulated by a user. In some embodiments, the connector is configured to secure to a separate piece of equipment, wherein the separate piece of equipment is configured to exert a desired combination of forces and moments on the device and the targeted piping section.

### BRIEF DESCRIPTION OF THE DRAWINGS

These and other features, aspects and advantages of the present application are described with reference to drawings of certain embodiments, which are intended to illustrate, but not to limit, the present disclosure. It is to be understood that the attached drawings are for the purpose of illustrating concepts disclosed in the present application and may not be to scale.

FIG. 1 illustrates a perspective view of a pipe handling device secured to a pipe section according to one embodiment;

FIG. 2 illustrates a detailed view of the device and piping section of FIG. 1;

FIGS. 3A and 3B illustrate detailed views of the head portion of the pipe handling device of FIGS. 1 and 2;

FIG. 4 illustrates a view of a strap of the pipe handling device according to one embodiment; and

FIG. 5 schematically illustrates two pipe handling devices secured to a piping section, according to one embodiment.

### DETAILED DESCRIPTION

According to some embodiments, a pipe handling device can be provided to improve the manipulation of pipe sections and similar members, including other tubular members, members with circular cross-sectional shapes or curved surfaces, members with square, rectangular or other polygonal cross-sectional shapes, irregular cross-sectional shapes, etc.

In some embodiments, the devices disclosed herein, or variations thereof, can be removably secured to the exterior of pipe sections or other tubular or elongated members. As illustrated herein, the devices can be configured to completely surround the circumference or other perimeter of the pipe or other elongated member. However, in other arrangements, the device can be configured to extend only along a portion of the circumference or perimeter of a pipe or other elongated member, as desired or required. Therefore, in some embodiments, the device does not completely surround the circumference or other perimeter of the pipe of other member being handled.

In the illustrated embodiments, the member being handled by a device comprises an elongated shape. For example, the elongated member comprises a length (e.g., a long dimension) that is greater than its diameter or other cross-sectional shape. In some arrangements, the length is at least 1.5, 2, 3, 4, 5, 6, 7, 8, 9, 10, 1.1 to 10, 1.5 to 5, 5 to 10, 1.5 to 10, 10 to 15, 15 to 20, 20 to 30, 30 to 50, values or ranges between the foregoing values and ranges, more than 50 times greater than its diameter or other cross-sectional shape.

Further, the various embodiments disclosed herein can help protect coatings, layers and/or other exterior features a pipe section during transportation, installation or other handling procedures. For instance, the piping section may include one or more coatings or layers to protect against corrosion, damage from UV light and/or other environmental conditions. In some embodiments, a coating or outer layer can include one or more ornamental layers, features and/or other members that are susceptible to damage from handling, either in addition to or in lieu of any protective coatings or features. In other configurations, the pipe section or other elongated member can include one or more hooks, fittings valves, ports and/or any other features. The embodiments disclosed herein can facilitate the handling and related procedures of the piping section or other elongated member (e.g., during transport, manipulation, handling, etc.) without damaging and/or interfering with (or, at least, reducing the likelihood of damage and/or interference of) such exterior features.

In some arrangements, the devices disclosed herein are hands-free devices such that a user can advantageously handle and/or otherwise manipulate a section of pipe without physically contacting (e.g., touching, with or without gloves) the corresponding pipe. Relatedly, as noted above, the various arrangements provided herein can help protect the piping or other member being handled (e.g., its exterior coatings, its exterior features, etc.). In some embodiments, “hands-free” can include devices that are used with at least partial human intervention (e.g., partial direct handling, indirect handling (e.g., using one or more additional devices, etc., etc.).

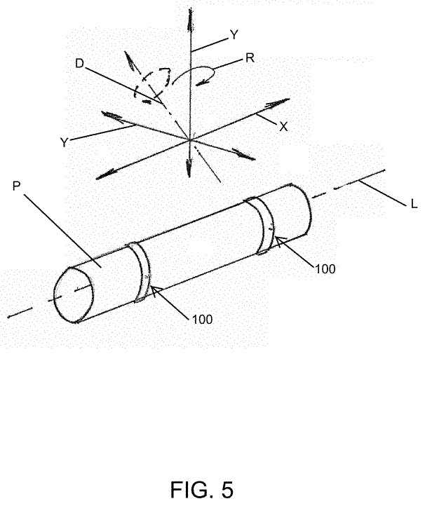

The pipe handling devices disclosed herein can help with the movement of pipes or other elongated members (e.g., by a user, by a crane or other equipment, etc.). In some embodiments, for example, as illustrated schematically in FIG. 5 and discussed in greater detail below, the devices can facilitate moving a piping section or other elongated member in any direction or manner (e.g., up or down, laterally, diagonally, rotationally about an axis, any combination of the foregoing, etc.), as desired or required.

In addition, the pipe handling devices discussed in the present application can improve the safety of various activities associated with the handling and installation of pipes (e.g., larger piping sections) and other elongated members. For instance, the devices can assist with exerting forces to move the pipe relative to a ground surface and/or rotate a pipe. As discussed, such movement or rotation of a pipe and/or other elongated member can be performed as part of a transportation, installation or other construction or field activity, other handling activity and/or the like. From a general perspective, any of the devices disclosed herein or equivalents thereof can assist with exerting a force or moment on a pipe or other member, with no (or reduced) contact with the pipe or other member.

Various embodiments of a pipe handling device disclosed in the present application can additionally improve safety. For example, the device can help eliminate or reduce the likelihood of pinch point protection (e.g., when putting pipe into welding clamps or a bending machine) or other trauma or injury. Further, the device can allow workers and other personnel to maintain greater distances relative to potentially dangerous suspended pipes, other members or other loads.

The device embodiments disclosed herein can be used with any piping type. For instance, the device can be secured to steel (e.g., carbon steel, stainless steel, etc.) pipes, iron pipes, other metallic pipes, plastic pipes, fiberglass pipes and/or the like. The pipes can include various lengths or configurations. Further, the devices can be used in connection with pipes of different diameters or sizes. For example, the devices can be secured to and used for moving pipes that are 6 inches to 48 inches or greater in diameter (e.g., 6 to 10, 10 to 24, 24 to 36, 36 to 48 inches, standard or non-standard diameters between the foregoing ranges, etc.), greater than 48 inches in diameter (e.g., 48 to 72, 72 to 96, 96 to 144 inches, standard or non-standard diameters between the foregoing ranges, etc.). As noted, the devices can be used to handle members that are not pipes (e.g., beams, other structural members, other elongated members, non-elongated members, etc.), as desired or required.

Although the embodiments of the various devices, systems and methods disclosed herein are described in the context of pipe handling and other piping applications (e.g., oil and gas industry, water delivery, wastewater or sewerage systems, industrial industries, etc.), the handling concepts (e.g., mechanical handling concepts), either alone or in conjunction with other concepts described herein, can also be implemented in other types of industries, applications and/or uses as well.

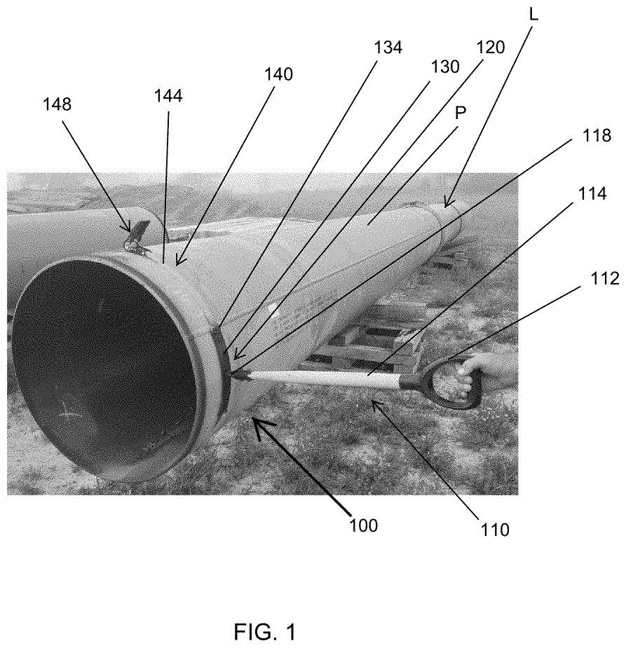

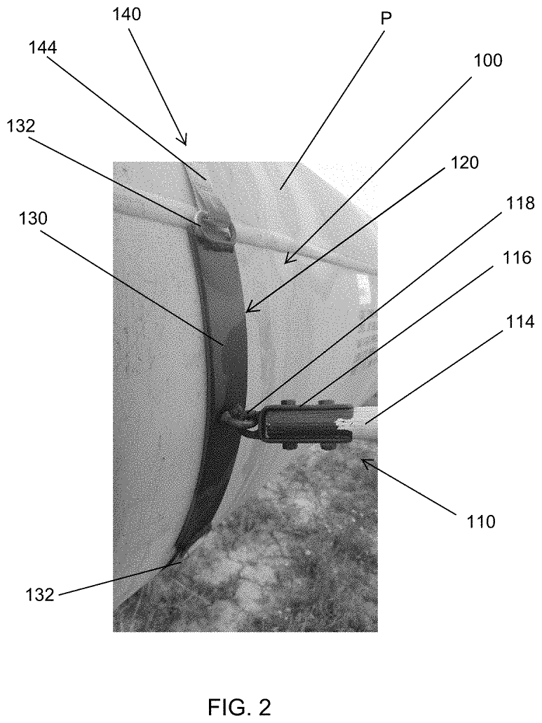

One embodiment of a pipe handling device 100 secured to a pipe P is illustrated in FIGS. 1 and 2. As shown, the pipe handling device 100 can include a head 120 that is shaped, sized and otherwise configured to be positioned along at least a portion of the outer surface of a pipe P or other elongated member. The head 120 can comprise a main body portion 130 that abuts or substantially abuts the adjacent exterior surface of the pipe P along the length of the main component. Thus, in some arrangements, the head 120 is curved (e.g., includes a curvature) to match or substantially match the shape of the pipe P or other member to which the device 100 can be attached. Accordingly, the head 120 can include a curved or partially-circular shape (e.g., with a constant radius of curvature, a varying radius of curvature, etc.).

With continued reference to FIGS. 1 and 2, the head 120 can include a rectangular shape that is curved, as discussed above, in accordance with the particular pipe P for which the pipe handling device 100 will be used. In some embodiments, the head 120 is rigid or semi-rigid. However, in alternative configurations, the head 120 is at least partially flexible or otherwise movable (e.g., to allow it to at least partially conform or substantially conform to the pipe P or other member to which the device 100 may secure).

In one embodiment, the head 120 is 2 inches by 12 inches in size (e.g., length, width and/or thickness), and has a thickness of one-eight inch. However, in alternative arrangements, the size (e.g., length, width and/or thickness) of the head 120 can vary, as desired or required for a particular application or use. For example, in some embodiments, the length of the head 120 (e.g., the dimension that extends in the direction of the circumference or perimeter of the pipe) can be smaller or greater than 12 inches (e.g., 2 to 4, 4 to 6, 6 to 8, 8 to 10, 10 to 12, 12 to 14, 14 to 18, 18 to 24 inches, values between the foregoing ranges, greater than 24 inches, less than 2 inches, etc.).

Likewise, the width of the head 120 (e.g., the dimension that extends in the direction of the longitudinal axis L of the pipe P (see FIG. 5) and the dimension that is perpendicular to the length) can be smaller or greater than 2 inches (e.g., 0 to 1, 1 to 2, 2 to 3, 3 to 4, 4 to 6, 6 to 8, 8 to 10, 10 to 12, 12 to 16, 16 to 20, 20 to 24 inches, values between the foregoing ranges, greater than 24 inches, etc.). Further, the thickness of the head 120 can be smaller or greater than one-eighth inch (e.g., 0 to 1/16, 1/16 to ⅛, ⅛ to 3/16, 3/16 to ¼, ¼ to ½, ½ to ¾, ¾ to 1, 1 to 1.25, 1.25 to 1.5 inches, thicknesses between the foregoing ranges, greater than 1.5 inches, etc.), as desired or required.

As noted above, in some embodiments, the head 120 is bendable, malleable and/or otherwise shapeable to permit the head 120 to at least partially conform or substantially conform to the outer (e.g., adjacent) shape of the pipe P or other elongated member to which the device 100 is configured to secure. Thus, in some arrangements, the head 120 is configured to permit the device 100 to be used on pipes and other elongated members of different shapes, sizes and other configurations. However, in other arrangements, the head 120 is rigid and not capable of being used in connection with differently sized or configured pipes or elongated members. Thus, in some embodiments, a kit can be provided that includes two or more differently sized and/or shaped head members 120. This can advantageously permit a user to utilize the device 100 on different types of pipes or other elongated members (e.g., by using the appropriate head for the targeted pipe or other elongated member).

In some embodiments, the head 120 comprises a rigid structure but includes a structure and/or configuration that permits it to at least partially conform or substantially conform to an exterior shape of a targeted pipe or other elongated member P, as desired or required. For instance, the head 120 can include one or more hinges, pivots, joints and/or other portions (not shown) that permit the head 120 to bend and/or otherwise move into various shapes.

The pipe handling device 100 can include more than one head member 120, as desired or required. For example, in some arrangements, the device 100 comprises two or more (e.g., 2, 3, 4, 5, more than 5, etc.) head members 120. The two or more head members 120 can be positioned immediately next to one another (e.g., so they are coupled to one another, in contact with one another, etc.). However, in alternative embodiments, the head members 120 are positioned away from one another (e.g., are separated). For example, a device 100 can include two head members 120 that are configured to be positioned along opposite sides of a pipe (e.g., spaced apart by 180 degrees or substantially 180 degrees from one another).

The head 120 can comprise one or more metals and/or alloys, such as, for example, steel (e.g., carbon steel, stainless steel, etc.), iron, other metals or alloys, etc. In other embodiments, the head 120 comprises one or more thermoplastic materials (e.g., plastic, rubber, etc.) and/or other non-metallic materials (e.g., wood or wood-based materials, fabric, other natural or synthetic materials, etc.).

In some embodiments, depending on the length of the head 120, size of the targeted pipe or other elongated member P, general configuration of the device 100 and/or one or more other factors, the head 120 can extend 5 to 50 degrees (e.g., 5 to 10, 10 to 15, 15 to 20, 20 to 25, 25 to 30, 30 to 35, 35 to 40, 40 to 45, 45 to 50, 5 to 50, 10 to 45, 10 to 25, 25 to 50 degrees, angle values or ranges between the foregoing, less than 5 degrees, greater than 40 degrees, etc.) about the center (e.g., center point) of the pipe or other elongated member P.

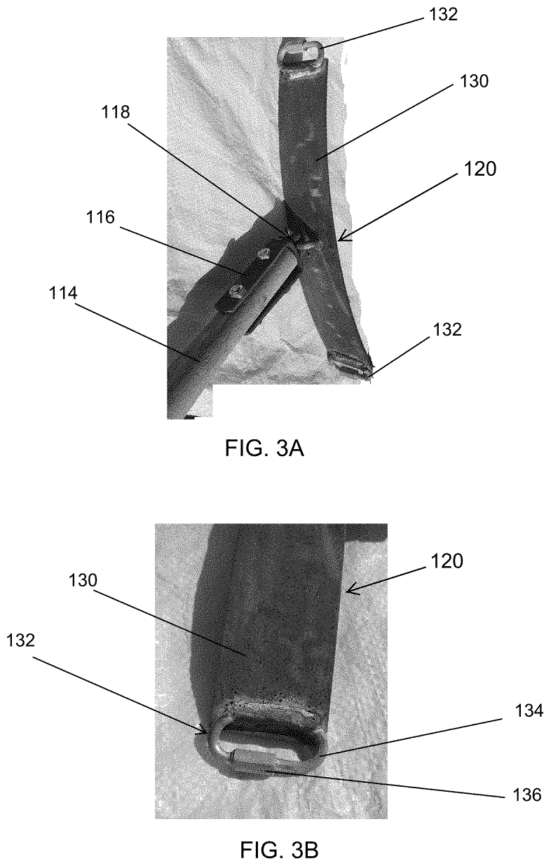

With continued reference to FIGS. 1 and 2, as well as FIGS. 3A and 3B, in some embodiments, the head 120 comprises one or more couplings 132 at or near each end of the main body 130 and the head 120. In some arrangements, a coupling 132 includes a quick-connect coupling to permit a user to quickly and easily connect and/or disconnect another component or device to the coupling 132. For instance, in the illustrated embodiment, the coupling 132 comprises a quick link coupling that is configured to be opened and closed by manipulating a threaded nut 136. Any other type of quick connect coupling 132 can be used for the pipe handling device, such as, for example, a karabiner or karabiner-like coupling, another type of spring-loaded or threaded coupling, any other type of fastener or mechanical coupling device, etc.

In the embodiment depicted in FIGS. 1 to 3, the couplings 132 comprise quick link couplings that are 2 inches wide and ¼-inch in diameter (or other cross-sectional dimension), with a curved configuration 134. Further, the illustrated couplings 132 are welded to the main body portion 130 of the head 120. However, the couplings can include any other shape, size, method of attachment to the head and/or any other configuration or property, as desired or required. The couplings 132 can be fixed to the head 120 or can be detachable or separable relative to the head 120.

As shown in FIGS. 1 and 2, the couplings 132 can be configured to receive (e.g., removably receive) a strap or other fastening member 140. The strap or other fastening member 140 can extend continuously or discontinuously from one coupling to the other coupling 132 (e.g., around the pipe P). Therefore, as illustrated in the figures, the pipe handling device 100 can comprise a single strap 140. However, in alternative configurations, the device 100 includes two or more straps (or strap portions) that are configured to couple to one another and/or the head 120 when positioned around a pipe section or other elongated member P (e.g., during use).

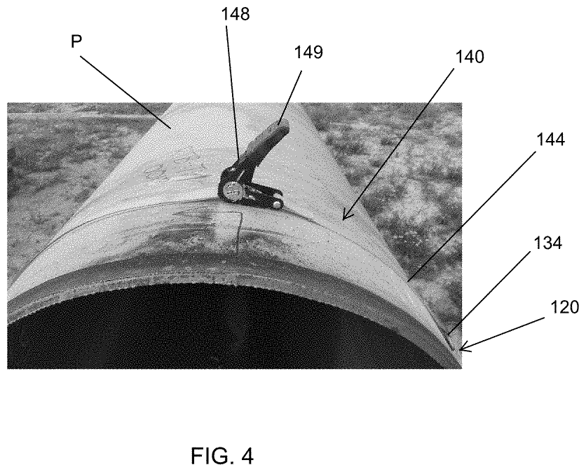

In some embodiments, the strap 140 comprises a strap with one or more ratcheting or tightening components or features (e.g., ratchet strap), as shown in FIGS. 1 and 4. A ratchet strap 140 can assist the user in selectively tightening the device 100 and/or loosening the device 100 relative to the targeted piping section P. In some arrangements, the strap 140 comprises a 1-inch wide strap comprising one or more thermoplastic materials (e.g., polyester webbing). However, the strap can include any other side (e.g., width), materials, construction and/or design, as desired or required.

With continued reference to FIGS. 1 and 2, regardless of its exact design, the strap 140 can be configured to secure to the couplings 132. The connection between the strap 140 and the couplings 132 can be fixed (e.g., not capable of being disconnected or decoupled without destroying or damaging the coupling or strap) or temporary. For example, in the illustrated embodiment, as noted above, the couplings 132 are quick connected couplings that can be moved to an open configuration to permit for the coupling or decoupling of a strap 140 (e.g., a loop shaped at an end of the strap) thereto.

In some arrangements, the head 120, the strap and/or any other portion of the device 100 comprise one or more intermediate or protective members that are configured to protect the pipe section or other targeted elongated member. For example, the interior surface (e.g., surface facing and immediately adjacent to the pipe) of the head 120 can include one or more layers of rubber or other intermediate members (not shown). Such a layer or other member can help prevent direct contact between the head 120 and the adjacent surface of the targeted pipe section P (e.g., to protect or safeguard the pipe or other member).

In the depicted arrangement, the protective member is 2 inches by 12 inches in size, and has a thickness of one-eight inch. Therefore, the protective member matches or substantially matches the size of the adjacent head 120. However, in alternative arrangements, the size (e.g., length, width and/or thickness) of the protective member can vary, as desired or required for a particular application or use. For example, in some embodiments, the length of the protective member (e.g., the dimension that extends in the direction of the circumference or perimeter of the pipe) can be smaller or greater than 12 inches (e.g., 2 to 4, 4 to 6, 6 to 8, 8 to 10, 10 to 12, 12 to 14, 14 to 18, 18 to 24 inches, values between the foregoing ranges, greater than 24 inches, less than 2 inches, etc.). Likewise, the width of the protective member (e.g., the dimension that extends in the direction of the longitudinal axis L of the pipe P (see FIG. 5) and the dimension that is perpendicular to the length) can be smaller or greater than 2 inches (e.g., 0 to 1, 1 to 2, 2 to 3, 3 to 4, 4 to 6, 6 to 8, 8 to 10, 10 to 12, 12 to 16, 16 to 20, 20 to 24 inches, values between the foregoing ranges, greater than 24 inches, etc.). Further, the thickness of the protective member can be smaller or greater than one-eighth inch (e.g., 0 to 1/16, 1/16 to ⅛, ⅛ to 3/16, 3/16 to ¼, ¼ to ½, ½ to ¾, ¾ to 1, 1 to 1.25, 1.25 to 1.5 inches, thicknesses between the foregoing ranges, greater than 1.5 inches, etc.), as desired or required.

The protective member can cover the adjacent inner surface of the head 120 in a continuous manner or in a discontinuous manner (e.g., wherein portions of the inner surface of the head are not uncovered). Further, the protective member can be attached to the head 120 using one or more securement techniques, methods, items or technologies (e.g., glues or other adhesives, screws or other mechanical fasteners and/or devices and/or any other device, component or method). In alternative embodiments, however, the protective member is positioned between the head 120 and the pipe without the need to secure the protective member to the head. The protective member can be securely maintained between the pipe or other elongated member P and the head 120 only by the force exerted by the head 120 in the direction of the pipe or other elongated member P (e.g., once the strap 140 is tightened around the pipe).

In alternative embodiments, no protective member is used. For example, the piping section or other elongated member does not have any special coatings or features that need to be protected. Alternatively, the head 120 itself can be configured to provide the necessary protection to the targeted piping section such that the need for an additional protective member is redundant or unnecessary.

In some embodiments, a protective member can be positioned not only between the head 120 and the exterior surface of a targeted pipe P, but also between the strap 140 and the pipe surface. The strap 140 can include such a protective member (e.g., continuously, intermittently, etc.) along one or more of its surfaces and/or portions. In other configurations, a protective member can be positioned around a longitudinal or axial location of the targeted pipe P where the device 100 will be secured. For instance, one or more layers can be applied around the circumference or perimeter of the piping section P along the longitudinal or axial locations of the piping section P where the user intends to secure a pipe handling device 100.

In some embodiments, the protective member, regardless if and how it is secured to the adjacent head 120 and/or strap 140, can be at least partially compressible, flexible or otherwise movable. This can provide sufficient flexibility in the device 100 once the strap is at least partially tightened around the targeted piping section P to accommodate for piping sections of varying diameter, shape, configuration, etc. Such a feature can be used in lieu of or in addition to a non-rigid (e.g., semi-rigid, flexible head 120), a movable head 120, providing two or more head members of different size, shape, configuration, etc.), as desired or required.

As illustrated in FIGS. 1, 2 and 3A, the pipe handling device 100 can include one or more connectors 118 that permit a user to selectively manipulate the device 100, and thus, the targeted piping section P to which the device 100 is removably secured. In the depicted embodiments, the connector 118 comprises a metallic (e.g., steel) loop member that is welded to the main body portion 130 of the head 120. However, in other arrangements, the connector 118 can include any other configuration, including type, size, shape, method of connection to head and/or the like.

With continued reference to the figures, one or more actuation or moving devices or members 114 can be fixedly or removably secured to the connector 118, as desired or required. In the illustrated embodiment, the actuation or moving device 114 comprises a handle or rod. Such a rod 114 can be grasped and selectively moved by a user to manipulate the piping section P to which the device 100 is secured. However, in other embodiments, the connector 118 can be configured to be secured to a crane, other equipment or mechanical device that is configured to help exert the desired movements to the device and the piping P.

As noted above, in the illustrated embodiment, the connector 118 includes a simple loop. However, in other arrangements, the connector 118 can include a joint (e.g., ball and socket joint), a hinge (e.g., lockable or non-lockable hinge), pivot point and/or the like, as desired or required.

As also noted above and illustrated in FIG. 5, two or more pipe handling devices 100 can be used along a single section of pipe or other targeted elongated member P. However, in other arrangements, only a single device 100 can be used for a particular section of piping P. Regardless of the exact configuration of the devices 100, the number of devices 100 used along a section of piping, the location of the devices relative to the piping and/or other details, by selectively exerting forces and/or moments to one or more devices 100 secured to a piping section, the piping section 100 can be advantageously translated (e.g., relative to a ground surface), rotated and/or otherwise moved without physical contact between a user (and/or any other equipment) and the piping section.

As illustrated schematically in FIG. 5, the one or more pipe handling devices 100 secured to a piing section P can help selectively translate the piping section P along one or more directions (e.g., X, Y, Z, D, etc.) and/or rotate R the piping section in a desired manner. Such movements can be advantageously accomplished without the user contacting the pipe surface directly, as discussed herein.

Such a configuration can provide enhanced handling of sections of pipe and other elongated members, especially when special coatings and/or other surface features of the piping make it detrimental or otherwise undesirable to directly contact the piping. Further, as noted above, the various embodiments disclosed herein can help improve safety as it relates to the manipulation and handling of piping sections or other elongated members P. For instance, using one or more pipe handling devices 100 can eliminate pinch point potential when moving pipes (e.g., placing them into welding clamps or bending apparatus). Further, the use of these devices 100 can allow workers and other personnel to maintain safe working distances from heavy suspended loads.

The systems, apparatuses, devices and/or other articles disclosed herein may be manufactured or otherwise formed through any suitable means. The various methods and techniques described above provide a number of ways to carry out the disclosed inventions. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the inventions disclosed herein.

Although several embodiments and examples are disclosed herein, the present application extends beyond the specifically disclosed embodiments to other alternative embodiments and/or uses of the inventions and modifications and equivalents thereof. It is also contemplated that various combinations or subcombinations of the specific features and aspects of the embodiments may be made and still fall within the scope of the inventions. Accordingly, it should be understood that various features and aspects of the disclosed embodiments can be combined with or substituted for one another in order to form varying modes of the disclosed inventions. Thus, it is intended that the scope of the present inventions disclosed herein should not be limited by the particular disclosed embodiments described above, but should be determined only by a fair reading of the claims that follow.

While the embodiments disclosed herein are susceptible to various modifications, and alternative forms, specific examples thereof have been shown in the drawings and are herein described in detail. It should be understood, however, that the inventions are not to be limited to the particular forms or methods disclosed, but, to the contrary, the inventions are to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers. For example, “about 10 mm” includes “10 mm.” Terms or phrases preceded by a term such as “substantially” include the recited term or phrase. For example, “substantially parallel” includes “parallel.”

What is claimed is:

1. A device for assisting manipulation of a targeted piping section, the device comprising:
a head member having a curved shape, the head member comprising a first end and a second end;
a first coupling positioned at or near the first end of the head member;
a second coupling positioned at or near the second end of the head member;
at least one strap configured to secure to the first end and the second end of the head member, the at least one strap being sized and configured to extend around the targeted piping section;
wherein the at least one strap is configured to tighten around the targeted piping section, wherein tightening of the at least one strap around the targeted piping section brings the head member toward an exterior surface of the targeted piping section; and
a connector coupled to the head member, wherein the connector is configured to secure to an actuator or movable device in order to exert desired forces or moments to the device and the targeted piping section to which the device is secured;
wherein use of the device eliminates the need for direct contact between a user and the targeted piping section.

2. The device of claim 1,
further comprising at least one protective member positioned at least partially between the head member and the targeted piping section;
wherein at least one of the first and second couplings is configured to be moved between open and closed positions to selective release and receive the at least one strap; and
wherein the at least one strap comprises a ratchet strap.

3. The device of claim 1, wherein at least one of the first and second couplings is configured to be moved between open and closed positions to selective release and receive the at least one strap.

4. The device of claim 3, wherein the at least one of the first and second couplings comprises a quick connect coupling.

5. The device of claim 1, wherein the at least one strap comprises a ratchet strap.

6. The device of claim 1, further comprising at least one protective member positioned at least partially between the head member and the targeted piping section.

7. The device of claim 6, wherein the protective member comprises a rubber or other elastomeric material.

8. The device of claim 6, wherein the at least one protective member is secured to the head member.

9. The device of claim 6, wherein the at least one protective member is not secured to the head member.

10. The device of claim 1, wherein the connector is fixedly secured to the head member.

11. The device of claim 1, wherein the connector is removably secured to the head member.

12. The device of claim 1, wherein the head member comprises a metal.

13. The device of claim 12, wherein the metal comprises steel.

14. The device of claim 1, wherein the connector is configured to secure to a rod, wherein the rod can be selectively manipulated by a user.

15. The device of claim 1, wherein the connector is configured to secure to a separate piece of equipment, wherein the separate piece of equipment is configured to exert a desired combination of forces and moments on the device and the targeted piping section.

16. A device for assisting manipulation of an elongated member, the device comprising:
a head member having a curved shape;
at least one strap configured to secure to a first end and a second end of the head member, the at least one strap being sized and configured to extend around the elongated member;
wherein the at least one strap is configured to tighten around the elongated member, wherein tightening of the at least one strap around the elongated member brings the head member toward an exterior surface of the elongated member; and
a connector coupled to the head member, wherein the connector is configured to secure to an actuator or movable device in order to exert desired forces or moments to the device and the elongated member to which the device is secured;
wherein use of the device eliminates the need for contact between a user and the elongated member.

17. The device of claim 16, further comprising at least one protective member positioned at least partially between the head member and the elongated member wherein the at least one strap comprises a ratchet strap.

18. The device of claim 16, wherein the elongated member comprises a pipe section.

19. The device of claim 16, wherein the connector is configured to secure to a rod, wherein the rod can be selectively manipulated by a user.

20. The device of claim 16, wherein the connector is configured to secure to a separate piece of equipment, wherein the separate piece of equipment is configured to exert a desired combination of forces and moments on the device and the elongated member.
